(19) United States
(12) Patent Application Publication
(10) Pub. No.: US 2023/0121906 A1
(43) Pub. Date: Apr. 20, 2023

(54) VEHICLE AND METHOD OF MANAGING CONTENT FOR THE SAME

(71) Applicants: HYUNDAI MOTOR COMPANY, Seoul (KR); KIA CORPORATION, Seoul (KR)

(72) Inventor: Hye Joo Lee, Bucheon-si (KR)

(73) Assignees: HYUNDAI MOTOR COMPANY, Seoul (KR); KIA CORPORATION, Seoul (KR)

(21) Appl. No.: 17/953,626

(22) Filed: Sep. 27, 2022

(30) Foreign Application Priority Data
Oct. 18, 2021 (KR) 10-2021-0138332

(51) Int. Cl. B60K 35/00; G06F 8/65

(52) U.S. Cl. CPC B60K 35/00; G06F 8/65; B60K 2370/52; B60K 2370/119; B60K 2370/589; B60K 2370/592; B60K 2370/731; B60K 2370/1529

(57) ABSTRACT

Disclosed are a head unit of a vehicle and a method for efficiently managing content of the head unit. In particular, the method for managing content for the head unit for the vehicle includes: receiving, from a server, a content change notification indicating an occurrence of a content change for a specific user; and, in response to the content change notification, either setting a content change flag for the specific user or immediately performing an update with the server according to the content change, based on an activation state of the vehicle and a user currently logged in the head unit.

### CROSS-REFERENCE TO RELATED APPLICATIONS

This application claims the benefit of and priority to Korean Patent Application No. 10-2021-0138332 filed on Oct. 18, 2021, in the Korean Intellectual Property Office, the entire contents of which are incorporated herein by reference.

### FIELD OF THE TECHNOLOGY

The present disclosure generally relates to a head unit for a vehicle, and more particularly to managing content of a head unit for a vehicle.

### BACKGROUND

According to a current trend, displays of head units in vehicles have increased in size. With this trend, the types of available content that can be displayed on a display of a head unit have diversified as users desire to view different types of content on larger displays of the head units. For example, users sometimes desire to select an image to be displayed on a display of a vehicle, in a similar way as observed from generalized functions of changing the wallpaper of a tablet, a laptop computer, or the like or customizing an idle screen by a user. Such functions are being developed in the form of a digital frame that allows images to be shared and used through a linkage of a cloud application account or a connected car service (CCS) account to a head unit of a vehicle.

The foregoing is intended merely to aid in the understanding of the background of the present disclosure, and is not intended to mean that the present disclosure falls within the purview of the related art that is already known to those having ordinary skill in the art.

### SUMMARY

The present disclosure provides a vehicle capable of updating content more conveniently and a content managing method for the vehicle.

However, technical aspects of the present disclosure are not limited to the foregoing aspects, and other technical aspects may also be present. Additional aspects of the disclosure are set forth in part in the description which follows and, in part, will be apparent from the description, or may be learned by practice of the presented embodiments of the disclosure.

According to an embodiment, there is provided a method for managing content of a head unit for a vehicle. The method may include: receiving, from a server, a content change notification indicating an occurrence of a content change for a specific user; and in response to the content change notification, either setting a content change flag for the specific user or performing an immediate update with the server according to the content change, based on a activation state of the vehicle and a user currently logged in the head unit.

In an aspect, when the activation state of the vehicle is a turned-on state, the performing may include performing the immediate update when the specific user and the currently logged user are the same.

In an aspect, when the activation state of the vehicle is the turned-on state, the performing may include setting the content change flag for the specific user if the specific user and the currently logged user are different.

In an aspect, when the activation state of the vehicle is a turned-off state, the receiving may include receiving a wake-up command from the server, and the performing may include setting the content change flag for the specific user and entering a sleep state.

In an aspect, as the content change flag is set when the activation state of the vehicle changes to the turned-on state after the entering of the sleep state, the performing may include comparing the specific user and the currently logged user. In this aspect, when the specific user and the currently logged user are the same based on a result of the comparing, the performing may further include performing the update.

In an aspect, when the specific user and the currently logged user are the same as each other based on the result of the comparing, the method may further include turning off the content change flag for the first user.

In an aspect, when the specific user and the currently logged user are different from each other based on the result of the comparing, the performing may further include maintaining the content change flag for the first user.

In an aspect, the performing of the update may include requesting and receiving thumbnail information including a thumbnail of each of at least one first content of which an original is stored in the server; when a selection command corresponding to at least a portion of at least one thumbnail included in the received thumbnail information is received, determining at least one third content of which an original is to be requested from the server based on the at least one thumbnail corresponding to the selection command and at least one second content of which an original is pre-stored in a memory of the head unit; and receiving the original of the at least one third content from the server.

In an aspect, when the original of the at least one third content is received from the server, the content managing method may further include outputting, through a display of the head unit, a content corresponding to the at least one thumbnail corresponding to the selection command.

According to another embodiment, there is provided a method for managing content of a head unit for a vehicle. The method may include: when the vehicle is started, verifying whether there is a content change flag set in response to a content change in a server; when it is determined, based on a result of the verifying, that there is a content change flag set, comparing a user corresponding to the content change flag and a currently logged user; when the users are the same based on a result of the comparing, performing an update based on the content change and turning off the content change flag; and when the users are different based on the result of the comparing, maintaining the content change flag.

According to still another embodiment, there is provided a head unit for a vehicle. The head unit may include a memory, a communicator configured to receive, from a server, a content change notification indicating an occurrence of a content change for a specific user, and a controller configured to set a content change flag for the specific user or immediately perform, on the memory, an update with the server according to the content change, based on a activation state of the vehicle and a currently logged user, in response to the content change notification.

In an aspect, when the activation state of the vehicle is a turned-on state, the controller may immediately perform the update when the specific user and the currently logged user are the same.

In an aspect, when the activation state of the vehicle is the turned-on state, the controller may set the content change flag for the specific user when the specific user and the currently logged user are different.

In an aspect, when the activation state of the vehicle is a turned-off state, the communicator may receive a wake-up command from the server, and the controller may set the content change flag for the specific user and enter a sleep state.

In an aspect, as the content change flag is set when the activation state changes to the turned-on state after the entering of the sleep state, the controller may compare the specific user and the currently logged user, and perform the update when the specific user and the currently logged user are the same as each other based on a result of the comparing.

In an aspect, when the specific user and the currently logged user are the same as each other based on the result of the comparing, the controller may turn off the content change flag.

In an aspect, when the specific user and the currently logged user are different from each other based on the result of the comparing, the controller may maintain the content change flag set for the specific user.

In an aspect, for performing the update, the communicator may request and receive thumbnail information including a thumbnail of each of at least one first content of which an original is stored in the server. In this aspect, when a selection command corresponding to at least a portion of at least one thumbnail included in the received thumbnail information is received, the controller may determine at least one third content of which an original is to be requested from the server based on the at least one thumbnail corresponding to the selection command and at least one second content of which an original is pre-stored in the memory of the head unit, and receive the original of the at least one third content from the server through the communicator.

In an aspect, the head unit may further include a display configured to output a content corresponding to the at least one thumbnail corresponding to the selection command when the original of the at least one third content is received from the server.

According to embodiments described herein, a vehicle may enable a more convenient update of content.

Specifically, whether to apply the update may be determined based on a power state of the vehicle and a user account of a user logged in a head unit of the vehicle, and thus contents in a most recent state for each user may be applied.

The effects that can be obtained from the present disclosure are not limited to the effects mentioned above, and unmentioned other effects may be clearly understood by those having ordinary skill in the art from the following description.

Additional advantages, objects, and features of the present disclosure will be set forth in part in the description which follows and in part will become apparent to those having ordinary skill in the art upon examination of the following or may be learned from practice of the disclosure. The objects and other advantages of the disclosure may be realized and attained by the structure particularly pointed out in the written description and claims hereof as well as the appended drawings.

### BRIEF DESCRIPTION OF THE DRAWINGS

In order that the disclosure may be well understood, there will now be described various forms thereof, given by way of example, reference being made to the accompanying drawings, in which:

FIG. 1 is a diagram illustrating an example configuration of a system for managing contents according to an embodiment of the present disclosure;

FIG. 2 is a diagram illustrating an example configuration of a head unit according to an embodiment of the present disclosure;

FIG. 3 is a flowchart illustrating an example of a content managing process according to an embodiment of the present disclosure;

FIG. 4 is a flowchart illustrating an example of a content updating process according to an embodiment of the present disclosure;

FIG. 5 is a flowchart illustrating another example of a content updating process according to an embodiment of the present disclosure;

FIG. 6 is a flowchart illustrating still another example of a content updating process according to an embodiment of the present disclosure; and

FIG. 7 is a flowchart illustrating the content updating process illustrated in FIGS. 5 and 6 to be performed on a side of a head unit according to an embodiment of the present disclosure.

The drawings described herein are for illustration purposes only and are not intended to limit the scope of the present disclosure in any way.

### DETAILED DESCRIPTION

Hereinafter, embodiments of the present disclosure are described in detail with reference to the accompanying drawings. In the drawings, the same or similar elements are given the same reference numerals regardless of reference symbols, and redundant description thereof is omitted. Further, in describing the embodiments disclosed in the present specification, when it is determined that a detailed description of related publicly known technology may obscure the gist of the embodiments disclosed in the present specification, the detailed description thereof is omitted. The accompanying drawings are used to help easily explain various technical features, and it should be understood that embodiments presented herein are not limited by the accompanying drawings. As such, the present disclosure should be construed to extend to any alterations, equivalents and substitutes in addition to those which are particularly set out in the accompanying drawings.

In the present specification, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof. When a component, device, element, or the like of the present disclosure is described as having a purpose or performing an operation, function, or the like, the component, device, or element should be considered herein as being “configured to” meet that purpose or to perform that operation or function.

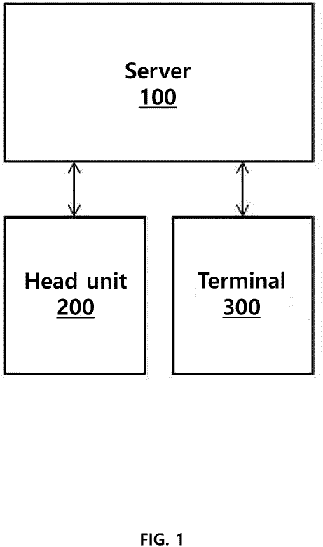

Hereinafter, a content managing method and a configuration of a device for performing the content managing method, according to embodiments, are described with reference to FIGS. 1 through 7. In the following description, content may be an image, but examples of which are not limited thereto. That is, any form of content, for example, content with which simplified information (e.g., a thumbnail) may be generated for content identification, and content that may be output/played via a head unit of a vehicle, may be applicable hereto. For example, a video may correspond to the content described herein because a thumbnail may be generated from a portion of the video. As another example, sound data may correspond to the content described herein because an album image or a singer image may be generated as a thumbnail when a song title, a musician, a singer, and the like are specified by metadata or a file name.

FIG. 1 is a diagram illustrating an example configuration of a system for managing content according to an embodiment.

Referring to FIG. 1, according to an embodiment, a system for managing content may include a server 100, a head unit 200, and a terminal 300.

The server 100 may perform wireless data communication with the head unit 200. For example, the server 100 may be implemented in the form of a connected car service (CCS) server or a telematics center, but is not necessarily limited thereto.

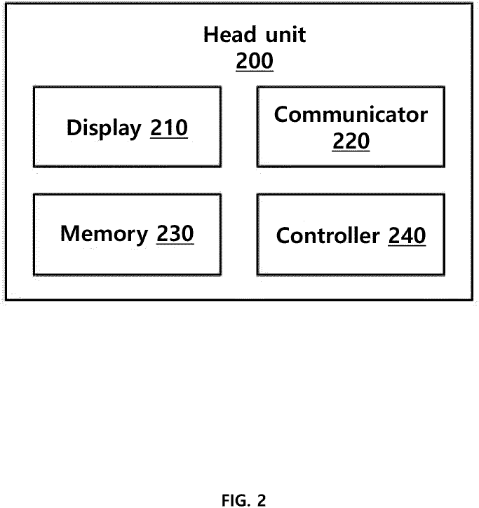

The head unit 200 may include a communicator (not shown in FIG. 1) for communicating with a display (not shown in FIG. 1) configured to display content and with the server 100. An example configuration of the head unit 200, according to an embodiment, is described in more detail below with reference to FIG. 2. The head unit 200 may transmit specification information and location information to the server 100. The specification information may include, for example, a display resolution, a supported image format, an image size for each mode (wait/background screen, split screen, etc.), a storage space, a maximum allowable number of contents to be stored, or the like.

The terminal 300 may be a smartphone but is not necessarily limited thereto. The terminal 300 may be, for example, a mobile terminal such as a smart tablet or a laptop, or a fixed terminal such as a personal computer (PC).

The server 100, the head unit 200, and the terminal 300 may be linked to one another via at least one account (e.g., a CCS account). In this case, the terminal 300 may upload, to the server 100, an image provided by a CCS application (or a cloud application) or the server 100, or an image captured by a camera of the terminal 300 or stored in the terminal 300, by logging into the server 100 with a corresponding account on a webpage linked to the server 100. In an embodiment, the server 100 may transmit, to the terminal 300, a specification of an image to be uploaded by referring to the specification information of the head unit 200, and the terminal 300 may process (e.g., resize, crop, etc.) the image accordingly and transmit the processed image to the server 100. According to another embodiment, the terminal 300 may upload an original image, and the server 100 may process the uploaded image by referring to the specification information and store the processed image. When uploading an image into the server 100, the terminal 300 may upload the image along with a thumbnail of the image. When the terminal 300 does not upload the thumbnail, the server 100 may generate a thumbnail for each uploaded image. In an embodiment, a single account may correspond to a single user. According to another embodiment, when user-specific setting management is available, a single account may correspond to a plurality of users.

In relation to the example embodiment described above, when a content change for a specific user occurs, for example, when new content is uploaded by an application of the terminal 300 or when a previously uploaded content is deleted, the server 100 may notify the head unit 200 of the occurrence of such a content change.

FIG. 2 is a diagram illustrating an example configuration of the head unit 200, according to an embodiment.

Referring to FIG. 2, the head unit 200 may include a display 210, a communicator 220, a memory 230, and a controller 240.

The communicator 220 may include a wireless communication modem (e.g., a long-term evolution (LTE) modem, etc.) that enables wireless data communication with the server 100.

The memory 230 may store therein various sets of input and output information of the head unit 200, an operating system (OS), applications, or the like. The memory 230 may store therein, for example, a digital frame application for displaying content on the display 210, an account management application for managing a user account, and images downloaded from the server 100.

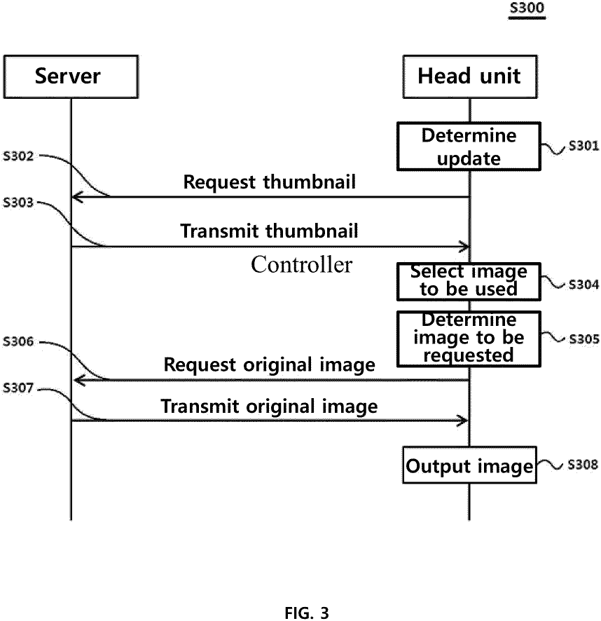

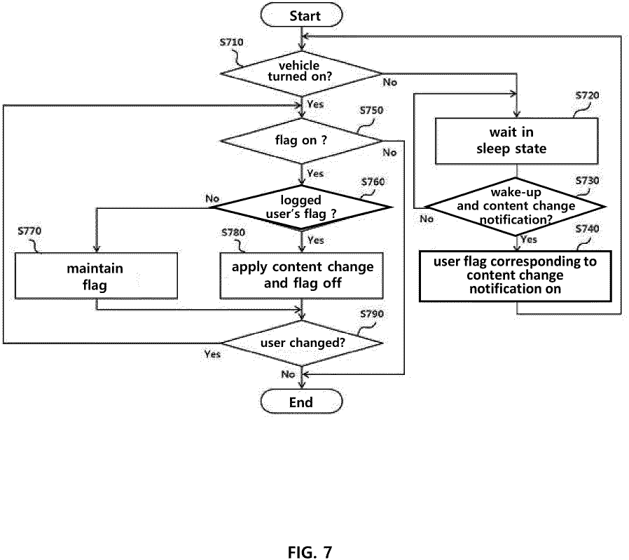

The controller 240 may perform overall control on the components described above, and may also perform computation, determination, selection, and the like that are required for content management and output functions. For example, the controller 240 may perform steps corresponding to operations of the head unit 200 described in more detail below with reference to FIGS. 3 through 6. The controller 240 may also perform computation, determination, selection, control, and the like for performing steps described in more detail blew with reference to FIG. 7.

According to an embodiment, when a content change for a specific user occurs in the server 100, the server 100 may notify the head unit 200 of the occurrence of the content change, and the head unit 200 may apply the content change at a desirable time based on a log-in state of the user corresponding to the content change and on a vehicle state.

As described in more detail below with reference to FIG. 3, although the time at which the content change occurring in the server 100 is to be applied to the head unit 200 may differ based on the log-in state of the user and the vehicle state, a procedure for the application may be similar once the head unit 200 determines that the content change is to be applied to the head unit 200.

FIG. 3 is a flowchart illustrating an example of a content managing process S300, according to an embodiment.

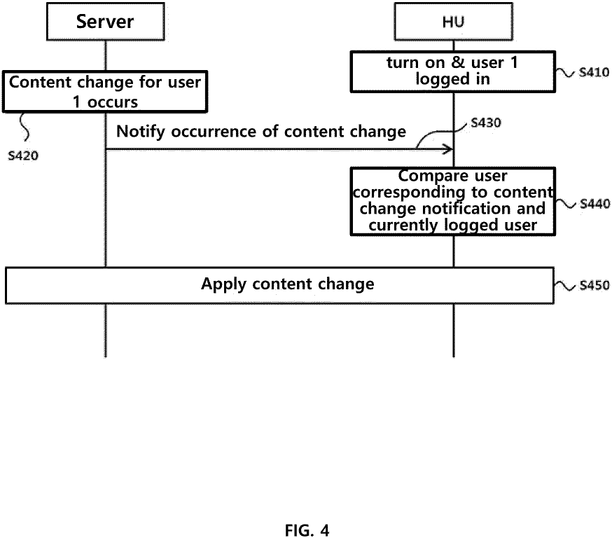

Referring to FIG. 3, in step S301, the head unit 200 may determine to apply (i.e., update) a content change, that occurred in the server 100, to the head unit 200. An example condition for the determining to apply a content change to the head unit 200 is described in more detail below with reference to FIGS. 4 through 7.

In step S302, in response to an update being determined, the head unit 200 may request the server 100 for at least one thumbnail of at least one stored image corresponding to a user currently logged in the head unit 200 using an account linked to the head unit 200.

In step S303, in response to the request, the server 100 may transmit the at least one thumbnail of the at least one original image stored in the server 100 to the head unit 200.

In step S304, the head unit 200 may output the received at least one thumbnail on the display 210 and receive, from the user, a selection of a thumbnail corresponding to an image to be output using an image display function. According to another embodiment, this step may be performed in advance by the terminal 300 when the terminal 300 requests the server 100 for a content update. In this case, the server 100 may transmit, to the head unit 200, information associated with a previously selected image in the terminal 300.

In step S305, the head unit 200 may compare thumbnail images corresponding to original images stored in the memory 230 to the selected thumbnail image, and may determine a target for which an original image is to be requested from the server 100. That is, the head unit 200 may determine that an original image is to be requested from the server 100 if an original image corresponding to the selected thumbnail is not among the original images that are stored (or held) in the memory 230. Also, an original image, among original images that are stored in the memory 230, that does not correspond to any thumbnail received from the server 100 may be deleted from the memory 230. This is, because an image held in the head unit 200 is generally downloaded into the head unit 200 from the server 100, if a corresponding thumbnail is not transmitted from the server 100, this may indicate that the user has deleted the image from the server 100, which shows an intention that the user would no longer use the image. Through such a deleting process, an original image that the user has no intention to use may be automatically deleted, which may prevent the capacity of the memory 230 from being unnecessarily consumed.

In step S306, based on a result of the determining, the head unit 200 may request the server 100 for the original image. In step S307, the server 100 may transmit the requested original image to the head unit 200. In step S308, the head unit 200 may thereby output the image selected in step S304 to the display 210. In this case, to request the original image, the head unit 200 may use a file name of the thumbnail, but examples are not necessarily limited thereto.

Hereinafter, a content updating process of a head unit performed in response to a content change in a server based on a user logged in the head unit and a vehicle state will be described with reference to FIGS. 4 through 7.

In the examples illustrated in FIGS. 4 through 7, it is assumed that a plurality of users can be logged into a head unit, and user 1 and user 2 among them are main users. In addition, a vehicle being activated, i.e., turned on, e.g., the engine being cranked, indicates that the head unit is turned on or in an on state, and the vehicle being in a turned-off state, e.g., the engine being turned off, indicates that the head unit is in a sleep state. According to an embodiment, even after the vehicle enters the turn-off state, the head unit may remain in the on state for a predetermined period of time and may then enter the sleep state after the predetermined period of time elapses. When the head unit is in the sleep state, the sleep state may be canceled in response to the vehicle entering the turned-on state or in response to a wake-up command from the server 100. In addition, it is assumed that a user logs in the head unit 200 when the head unit 200 is in the on state, and the user who logs in once remains logged in even when the head unit 200 enters the sleep state, unless another user logs in (i.e., user change) in a power-on state.

FIG. 4 is a flowchart illustrating an example of a content updating process according to an example embodiment of the present disclosure.

Referring to FIG. 4, in step S410, a vehicle including the head unit 200 may be turned on or in a turned-on state, and user 1 may be logged in the head unit 200.

In step S420, a content change for user 1 may occur in the server 100 due to, for example, uploading a new image via the terminal 300 to the server 100 or deleting an image pre-stored in the server 100.

In step S430, the server 100 may transmit, to the head unit 200, a content change notification indicating the occurrence of the content change for user 1.

The head unit 200 may compare a user corresponding to the content change notification to the currently logged user in step S440, and may apply the content change when the users are the same in step S450. Step S450 for applying the content change may be performed in accordance with the process S300 described above with reference to FIG. 3.

When the users are different in step S440, the head unit 200 may set a content change flag to be ‘on’ for the user corresponding to the content change notification.

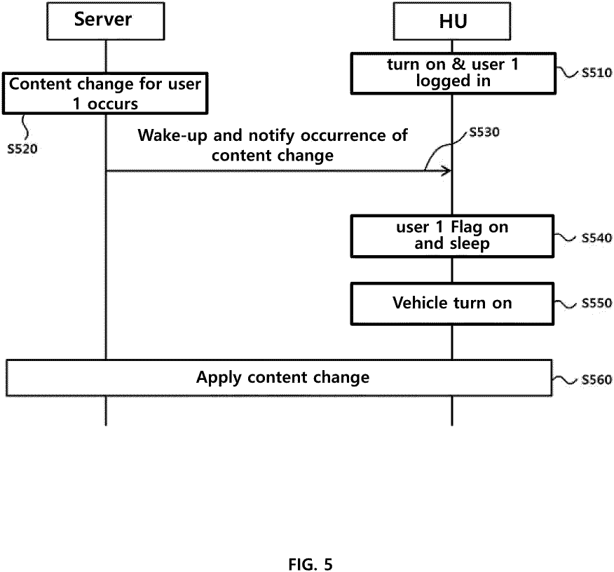

FIG. 5 is a flowchart illustrating another example of a content updating process according to an embodiment of the present disclosure.

Referring to FIG. 5, in step S510, a vehicle including the head unit 200 may be in a turned-off state, and user 1 may be logged in the head unit 200.

In step S520, a content change for user 1 may occur in the server 100 due to, for example, uploading a new image via the terminal 300 to the server 100 or deleting an image pre-stored in the server 100.

In step S530, the server 100 may wake up the head unit 200 and transmit, to the head unit 200, a content change notification indicating the occurrence of the content change for user 1.

In step S540, the head unit 200 may set a content change flag to be ‘on’ for the user (i.e., user 1) corresponding to the content change notification, and return to a sleep state.

Subsequently, when the vehicle is started in step S550, the head unit 200 may verify that the content change flag for the currently logged user (i.e., user 1) is ‘on,’ and apply the content change in step S560. Step S560 for applying the content change may be performed in accordance with the process S300 described above with reference to FIG. 3.

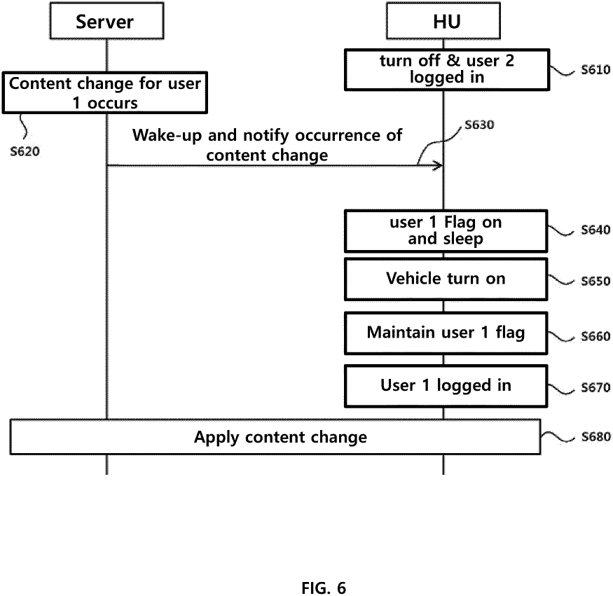

FIG. 6 is a flowchart illustrating still another example of a content updating process according to another embodiment of the present disclosure.

Referring to FIG. 6, in step S610, a vehicle including the head unit 200 may be in a turned-off state, and user 2 may be logged in the head unit 200.

In step S620, a content change for user 1 may occur in the server 100 due to, for example, uploading a new image via the terminal 300 to the server 100 or deleting an image pre-stored in the server 100.

In step S630, the server 100 may wake up the head unit 200 and may transmit, to the head unit 200, a content change notification indicating the occurrence of the content change for user 1.

In step S640, the head unit 200 may set a content change flag to be ‘on’ for the user (i.e., user 1) corresponding to the content change notification, and return to a sleep state.

Subsequently, when the vehicle is started in step S650, the head unit 200 may check the content change flag to verify that the content change flag for another user (i.e., user 1) who is not the currently logged user (i.e., user 2) is set as ‘on,’ and maintain the content change flag as the same as before in step S660.

Subsequently, when user 1 is logged in in step S670, the head unit 200 may check the content change flag to verify that a content change flag for the currently logged user (i.e., user 1) is set as ‘on,’ and apply the content change in step S680. Step S680 for applying the content change may be performed in accordance with the process S300 described above with reference to FIG. 3.

FIG. 7 is a flowchart illustrating the content updating process illustrated in FIGS. 5 and 6 to be performed by a head unit.

Referring to FIG. 7, when the vehicle is in the turned-off state (No in S710), the head unit 200 may wait in the sleep state in step S720. When receiving a wake-up command and a content change notification from the server 100 (Yes in S730), the head unit 200 may store, as an ‘on’ state, a content change flag for a user corresponding to the content change notification in step S740.

When the vehicle is started or in the turned-on state (Yes in S710), the head unit 200 may verify whether there is a content change flag set as ‘on’ in step S750. When there is a content change flag set as ‘on’ (Yes in S750), the head unit 200 may verify whether the content change flag is a content change flag for a currently logged user in step S760. When a user corresponding to the content change flag is different from the currently logged user (No in S760), the head unit 200 may maintain the content change flag to be in the on state in step S770. In contrast, when the user corresponding to the content change flag is the same as the currently logged user (Yes in S760), the head unit 200 may perform the content updating process S300 described above with reference to FIG. 3, and set the content change flag to be ‘off in step S780.

When a step (e.g., S770 or S780) related to the content change flag processing is completed and a user changes (Yes in S790), step S750 may be performed again.

According to example embodiments described herein, when a vehicle is in a turned-on state and a user corresponding to a content change occurring in the server 100 is currently logged in, the content change may be immediately applied to the head unit 200. Further, even when the user logged in the head unit 200 and the user corresponding to the content change occurring in the server 100 are different, the changed content may be immediately applied when the user corresponding to the content change is logged into the head unit 200 through flag setting. In addition, even when the vehicle is in a turned-off state, the flag setting may be available through wake-up of the head unit 200, and thus an update may be applied based on a user who logs in when the vehicle is in a next turned-on state.

In addition, in an environment where data usage is limited, it is possible to use optimized data through the updating process described above with reference to FIG. 3. That is, rather than selecting an image to be displayed after receiving all original images from the server 100, determining an original image required to be practically downloaded after receiving only a thumbnail may save memory in the memory 230 of the head unit 200 in addition to decreasing an amount of wireless data usage. Further, an image of which an original image is deleted from the server 100 may be automatically deleted from the memory 230, and it is thus possible to prevent original images that a user has no intention to use from being accumulated in the memory 230.

The present disclosure described above may be embodied as computer-readable code on a medium in which a program is recorded. The computer-readable medium includes all types of recording devices in which data readable by a computer system is stored. Examples of the computer-readable medium include a hard disk drive (HDD), a solid-state drive (SSD), a silicon disk drive (SDD), a read-only memory (ROM), a random-access memory (RAM), a compact disc (CD)-ROM (CD-ROM), a magnetic tape, a floppy disk, an optical data storage device, etc.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the above detailed description should not be construed as restrictive and should be considered as illustrative in all respects. The scope of the present disclosure should be determined by a reasonable interpretation of the appended claims, and all modifications within the equivalent scope of the present disclosure are included in the scope of the present disclosure.

What is claimed is:

1. A method for managing content of a head unit for a vehicle, the method comprising:
receiving, from a server, a content change notification indicating an occurrence of a content change for a first user; and
in response to the content change notification, performing an operation by the head unit based on an activation state of the vehicle and a second user currently logged in the head unit the operation being one of i) setting, by the head unit, a content change flag for the first user and ii) performing, by the head unit, an update with the server according to the content change for the first user.

2. The method of claim 1, wherein, when the activation state of the vehicle is a turned-on state and the first user and the second user currently logged in the head unit are the same, performing the operation comprises performing the update according to the content change for the first user.

3. The method of claim 1, wherein, when the activation state of the vehicle is a turned-on state and the first user and second user currently logged in the head unit are different, performing the operation comprises setting the content change flag for the first user.

4. The method of claim 1, wherein, when the activation state of the vehicle is a turned-off state,
receiving the content change notification includes receiving a wake-up command from the server,
performing the operation comprises setting the content change flag for the first user and entering a sleep state of the head unit.

5. The method of claim 4, further comprising:
when the content change flag is set for the first user and the activation state of the vehicle changes to a turned-on state after entering of the sleep state,
comparing the first user and the second user currently logged in the head unit, and
when the first user and the second user currently logged in the head unit are the same based on a result of the comparing, performing the update according to the content change for the first user.

6. The method of claim 5, further comprising: when the first user and the second user currently logged in the head unit are the same based on the result of the comparing, turning off the content change flag set for the first user.

7. The method of claim 5, further comprising: when the first user and the second user currently logged in the head unit are different based on the result of the comparing, maintaining the content change flag set for the first user.

8. The method of claim 1, wherein performing the update comprises:
requesting and receiving thumbnail information comprising a thumbnail of each of at least one first content of which an original is stored in the server;
when a selection command corresponding to at least a portion of at least one thumbnail in the received thumbnail information is received, determining at least one third content of which an original is to be requested from the server based on the at least one thumbnail corresponding to the selection command and at least one second content of which an original is pre-stored in a memory of the head unit; and
receiving the original of the at least one third content from the server.

9. The method of claim 8, further comprising:
when the original of the at least one third content is received from the server, outputting, via a display of the head unit, a content corresponding to the at least one thumbnail corresponding to the selection command.

10. A method for managing content of a head unit for a vehicle, the method comprising:
when the vehicle is activated, determining whether there is a content change flag that is set in response to a content change in a server;
in response to determining that there is a content change flag that is set, comparing a first user corresponding to the content change flag that is set and a currently logged second user; and
when it is determined, based on a result of the comparing, that the first user and the second user are the same, i) performing an update based on the content change and ii) turning off the content change flag, and
when it is determined, based on the result of the comparing, that the first user and the second user are not the same, maintaining the content change flag.

11. A head unit for a vehicle, comprising:
a memory;
a communicator configured to receive, from a server, a content change notification indicating an occurrence of a content change for a first user; and
a controller configured to, in response to the content change notification, one of i) set a content change flag for the first user and ii) perform, on the memory, an update with the server according to the content change for the first user, based on an activation state of the vehicle and a currently logged second user.

12. The head unit of claim 11, wherein the controller is configured to, when the activation state of the vehicle is a turned-on state and the first user and the currently logged second user are the same, immediately perform the update according to the content change for the first user.

13. The head unit of claim 11, wherein the controller is configured to, when the activation state of the vehicle is a turned-on state and the first user and the currently logged second user are different from each other, set the content change flag for the first user.

14. The head unit of claim 11, wherein, when the activation state of the vehicle is a turned-off state,
the communicator is configured to receive a wake-up command from the server, and
the controller is configured to set the content change flag for the first user and cause the head unit to enter a sleep state.

15. The head unit of claim 14, wherein the controller is configured to, when the activation state of the vehicle changes to a turned-on state after the head unit enters the sleep state,
compare the first user for which the content change flag is set and the currently logged second user, and
when the first user and the currently logged second user are determined to be the same based on a result of the comparing, perform the update according to the content change for the first user.

16. The head unit of claim 15, wherein when the first user and the currently logged second user are determined to be the same, the controller is further configured to turn off the content change flag for the first user.

17. The head unit of claim 15, wherein when the first user and the currently logged second user are determined to be different from each other, the controller is configured to maintain the content change flag set for the first user.

18. The head unit of claim 11, wherein, the communicator is configured to:
request and receive thumbnail information comprising a thumbnail of each of at least one first content of which an original is stored in the server, and
wherein the controller is configured to:
when a selection command corresponding to at least a portion of at least one thumbnail comprised in the received thumbnail information is received, determine at least one third content of which an original is to be requested from the server based on the at least one thumbnail corresponding to the selection command and at least one second content of which an original is pre-stored in the memory of the head unit, and receive the original of the at least one third content from the server through the communicator.

19. The head unit of claim 18, further comprising:
a display configured to, when the original of the at least one third content is received from the server, output a content corresponding to the at least one thumbnail corresponding to the selection command.
